(19) United States
(12) Patent Application Publication
(10) Pub. No.: US 2021/0103864 A1
(43) Pub. Date: Apr. 8, 2021

(54) Computer System and Method for Facilitating Creation and Management of an Inspection and Test Plan for a Construction Project

(71) Applicant: Procore Technologies, Inc., Carpinteria, CA (US)

(72) Inventors: Luisa Goytia, Santa Barbara, CA (US); Wojciech Peliks, Santa Barbara, CA (US)

(21) Appl. No.: 16/593,924

(22) Filed: Oct. 4, 2019

(51) Int. Cl. G06Q 10/06; G06Q 50/08

(52) U.S. Cl. CPC G06Q 10/0637; G06Q 10/0635; G06Q 50/08; G06Q 10/06316

(57) ABSTRACT

Disclosed herein is an interactive software tool for facilitating the creation, management, and tracking of an ITP for a construction project, which may be referred to as an “ITP software tool.” In one aspect, the disclosed ITP software tool may provide a first interface through which users can create a new ITP for a construction project. In another aspect, the disclosed ITP software tool may include a software engine that functions to automatically define inspection and test activities for inclusion in the ITP. In yet another aspect, the disclosed ITP software tool may provide a second interface through which users can manage and track the status of an existing ITP for a construction project. In still another aspect, the disclosed ITP software tool may include a software engine that employs predictive analytics in order to identify potential problems with an existing ITP for a construction project.

### BACKGROUND

Construction projects can be complex endeavors that involve collaboration between multiple different parties. For instance, an owner may be responsible for funding a construction project and collaborating with an architect on its design. The architect may then collaborate with a general contractor (“GC”) that has been tasked with managing the overall construction project. In turn, the GC may collaborate with various subcontractors that have been tasked with handling specific aspects of the construction project, such as concrete, carpentry, masonry, roofing, electrical, plumbing, HVAC, etc.

Further, construction projects typically involve various phases, one of which may be a planning phase that involves the creation of a set of plans that are to govern the subsequent phases of the construction project (e.g., the execution and/or closure phases). In this respect, one type of plan that may need to be created during a planning phase of a construction project is an inspection and test plan (“ITP”), which specifies the set of inspections and tests that must be completed on the construction project before it can be closed out. In practice, this set of inspections and tests that must be completed on the construction project is typically dictated by certain specifications associated with the construction project, which may take the form of standardized specifications and/or project-specific specifications (e.g., project drawings). Further, in practice, the ITP may also include requirements as to the manner in which the inspections and tests must be completed on the construction project (where such requirements may also be dictated by the specifications), including but not limited to requirements as to when the inspections and tests must be completed and/or requirements as to the individual(s) responsible for completing the inspections and tests.

After an ITP for a construction project has been created during a planning phase of the construction project, the ITP may then be used to manage quality control on the construction project during execution and/or closure phases of the construction project. In practice, this task may involve consulting the ITP to identify the inspections and/or tests that need to be completed on the construction project, performing such inspections and/or tests in accordance the requirements set forth in the ITP, and then providing confirmation that such inspections and/or tests have been completed in accordance with the requirements set forth in the ITP.

### Overview

Conventionally, ITPs for construction projects have been created and managed using rudimentary spreadsheets that comprise simple, textual descriptions of the set of inspections and tests that must be completed on a construction project, perhaps along with columns that allow individuals responsible for such inspections and tests (referred to herein as “testers”) to type and/or handwrite additional textual information into such columns upon completion of the inspections and tests. However, these rudimentary spreadsheet-based ITPs have several drawbacks.

First, because a spreadsheet-based ITP typically only includes typed or handwritten textual information about the inspections and tests for a construction project, this limits the usability of the ITP—particularly when it comes to evidencing that a given inspection or test has been completed. For instance, with a spreadsheet-based ITP, a tester that has been tasked with completing a given inspection or test typically only has the ability to type or handwrite a free-form textual description of the underlying records that allegedly evidence completion of the given inspection or test, which makes it cumbersome for an individual tasked with managing the ITP for the construction project (referred to herein as an “ITP manager”) to verify that the given inspection or test was completed properly. Indeed, it is often the case that the ITP manager has to interpret the tester's free-from textual description of the underlying records in the spreadsheet-based ITP and then either follow up with the tester to obtain the underlying records or go pull the underlying records from a common repository related to the construction project, which is inefficient and prone to mistakes.

Second, given the free-from nature of a spreadsheet-based ITP, it is very difficult to control the manner in which the inspections and tests in the ITP are closed out. For instance, with a spreadsheet-based ITP, it is very difficult to impose restrictions on who is permitted to close out a given inspection or test in the ITP, the timing of when a given inspection or test in the ITP can be closed out, or the nature of the information that is added to the ITP when a given inspection or test in the ITP is closed out. As a result, a greater burden is placed on the ITP manager to ensure that the inspections and tests in the ITP are being closed out by the appropriate individuals, at the appropriate times, and with the appropriate supporting information.

To help overcome these and other drawbacks with existing approaches for creating and managing ITPs for construction projects, disclosed herein is an interactive software tool for facilitating the creation, management, and tracking of an ITP for a construction project, which may be referred to as an “ITP software tool.” The disclosed ITP software tool may include various aspects and take various forms.

In one aspect, the disclosed ITP software tool may provide a first interface through which users can create a new ITP for a construction project. This first interface—and the manner in which ITPs may be created via this first interface—may take various forms.

For instance, the first interface may provide a user with the ability to define general information for a new ITP for a construction project, such as a name of the ITP, a type of work to which the ITP relates (e.g., concrete), a textual description of the ITP, and/or a particular manager of the ITP, among other examples.

Further, the first interface may provide a user with the ability to define, on an activity-by-activity basis, the inspection and test activities that are to be included in the ITP for the construction project. In this respect, the first interface may present a user with a variety of different fields that can be used to define a given inspection or test activity, examples of which may include a title of the given activity, a textual description of the given activity, a reference link to a particular specification that forms the basis for the given activity, a due date for the given activity, an identification of one or more individuals that are responsible for completing and closing out the given activity (referred to herein as “assignee(s)”), an indication of any “hold point condition” for the given activity (i.e., a condition specifying that certain other activities in the ITP are not to be performed until the given activity is closed out), and/or an indication of whether any particular record type(s) are required to evidence completion of the given activity, among other possibilities.

Further yet, in connection with providing a user with the ability to define the inspection and test activities that are to be included in the ITP for the construction project, the first interface may additionally provide the user with the ability to group and sequence the inspection and test activities in the ITP in various manners. For instance, the first interface may additionally provide the user with the ability to group certain inspection and test activities in the ITP together into different “sections” of the ITP, define a particular sequence for different sections of inspection and test activities, and/or define a particular sequence for inspection and test activities included within a particular section. In this respect, the grouping and/or sequencing of inspection and test activities in the ITP may provide an indication of the relationship between different inspection and test activities in the ITP (and perhaps also an indication of when certain inspection and activities are to be completed relative to one another).

Still further, the first interface may provide a user with the ability to publish the ITP once the general information and the inspections and tests have been defined, which may cause the ITP software tool to finalize the ITP and make it available for use during the execution and/or closure phases of the construction project.

This first interface may take other forms and/or enable a user to perform other tasks related to the creation of an ITP for a construction project as well.

In another aspect, the disclosed ITP software tool may include a software engine that functions to automatically define inspection and test activities for inclusion in the ITP. For instance, such a software engine may function to evaluate specifications associated with a construction project (e.g., by searching for relevant terms like “quality” or “inspection”), and then based on that evaluation, automatically define one or more inspection and test activities for inclusion in the ITP. In this respect, the disclosed ITP software tool either may automatically add the inspection and test activities that are defined by the software engine to the ITP or may present a user with an opportunity to approve, reject, and/or modify the inspection and test activities that are defined by the software engine before they are added to the ITP.

Along similar lines, the software engine may also be capable of detecting a change to a specification associated with a construction project after the ITP for the construction project has been published and then automatically updating certain inspection and test activities in the ITP in accordance with the detected change(s) to the specification.

In yet another aspect, the disclosed ITP software tool may provide a second interface through which users can manage and track the status of an existing ITP for a construction project. This second interface—and the manner in which ITPs may be managed and tracked via this second interface—may take various forms.

For instance, as an initial matter, the second interface may present a user with the general information for the ITP and the set of inspections and tests included in the ITP. In this respect, the presentation of the set of inspections and tests may include some or all of the defining information for the inspection and test activities, including but not limited to the titles of the activities, textual descriptions of the activities, reference links to particular specifications that form the basis for the activities, due dates for the activities, assignees for the activities, hold point conditions for the activities, and/or indications of required record types for the activities, among other possibilities.

Further, the second interface may present a user with the ability to link a record to a given inspection or test activity that evidences completion of the given activity. For example, if the defining information for a given inspection or test activity includes an indication that a record of a given type needs to be provided in order to close out the given activity, the second interface may present that indication in the form of text having an embedded link, which a user can click (or otherwise select) in order to launch a workflow for linking a record of the given type to the given activity. As another example, the second interface may present a selectable “Add Records” button for a given inspection or test activity, which a user can click (or otherwise select) in order to launch a workflow for linking records of various types to the given activity. The second interface may enable a user to link a record to a given inspection or test activity in other manners as well. After receiving a user's request to link a given record to a given inspection or test activity, the ITP tool may update the presentation of the inspections and tests included in the ITP to indicate that the record has been linked to the given activity.

Further yet, the second interface may present each assignee of a given inspection or test activity with the ability to sign off on completion of the given activity. For example, as part of presenting the defining information for a given inspection or test in the ITP, the second interface may present an assignee's name in the form of a text having an embedded link, which a user can click (or otherwise select) in order to launch a workflow that enables the assignee to sign off on completion of the given activity by inputting the assignee's name and electronic signature. However, the second interface may enable a user to sign off on completion of a given inspection or test activity in other manners as well. After receiving an assignee's sign-off information for the given activity, the ITP tool may then validate the sign-off information, and then if that validation is successful, the ITP tool may update the presentation of the inspections and tests included in the ITP to indicate that the assignee has successfully signed off on the given activity.

Still further, to the extent that the defining information for the inspection and test activities in the ITP include hold point conditions, the second interface may use these hold point conditions along with the grouping and/or sequencing of the ITP as a basis for placing conditional restrictions on a user's ability to interact with certain inspection and test activities in the ITP (e.g., by “locking” such activities so that a user cannot link records or sign off on completion).

For example, a given inspection or test activity may have a “Rest of Plan” hold point condition (which may also be referred to herein as a “Rest of Table” hold point condition), which is a condition dictating that no activities sequenced after the given activity in the ITP are to be performed until the given activity is closed out, in which case the second interface may restrict a user's ability to interact with any successive activity in the ITP unless and until the given activity is closed out. As another example, a given inspection or test activity may have a “Rest of Section” hold point condition, which is a condition dictating that no activities sequenced after the given activity in a particular section of the ITP are to be performed until the given activity is closed out, in which case the second interface may restrict a user's ability to interact with any successive activity in the particular section of the ITP unless and until the given activity is closed out. Other examples are possible as well.

For a given inspection or test activity that has such a hold point condition, the disclosed ITP software tool may then keep track of whether the given activity has met the necessary criteria to be closed out, which may take various forms. As one possibility, such criteria may look at (a) whether each required record type (or at least one record of any type, if no particular record type is specified) has been linked to the given activity to evidence completion and (b) whether each required assignee has signed off on the completion of the given activity. As another possibility, such criteria may look at not only whether each required record type has been linked to the given activity to evidence completion, but also whether the content of the linked record(s) are sufficient to evidence completion of the given activity. The criteria used to determine whether an inspection or test activity has been closed out may take various other forms as well.

In turn, once it is determined that the given activity has met the necessary criteria to be closed out, the disclosed ITP software tool may then release the restriction on a user's ability to interact with one or more successive activities for which user interaction was previously restricted based on the given activity's hold point condition. In this respect, the disclosed ITP software tool may determine which of the successive activities in the ITP are to be “unlocked” and which of the successive activities in the ITP are to remain “locked” based on the grouping and/or sequencing of the ITP, the particular type of hold point condition defined for the given activity, and the existence of hold point conditions for any of the successive activities in the ITP.

For example, if a first activity in the ITP's sequence has a “Rest of Plan” hold point condition, then closing out the first activity may cause the disclosed ITP software tool to unlock every successive activity in the ITP's sequence up to and including the next successive activity that has a hold point condition. In this respect, if the next successive activity having a hold point condition is the second activity in the ITP's sequence, the disclosed ITP software tool may only unlock the second activity (while keeping all other successive activities locked pending close out of the second activity), whereas if the next successive activity having a hold point condition is the third activity in the ITP's sequence, the disclosed ITP software tool may unlock the second and third activities (while keeping all other successive activities locked pending close out of the third activity), and so on.

As another example, if a first activity in a section of the ITP has a “Rest of Section” hold point condition, then closing out the first activity may cause the disclosed ITP software tool to unlock every successive activity in the section up to and including the next successive activity in the section having a hold point condition. In this respect, if the next successive activity in the section having a hold point condition is the second activity in the section's sequence, the disclosed ITP software tool may only unlock the second activity (while keeping all other successive activities in the section locked pending close out of the second activity), whereas if the next successive activity in the section having a hold point condition is the third activity in the section's sequence, the disclosed ITP software tool may unlock the second and third activities (while keeping all other successive activities in the section locked pending close out of the third activity), and so on.

This second interface may take other forms and/or enable a user to perform other tasks related to the management and tracking of an ITP for a construction project as well.

In still another aspect, the disclosed ITP software tool may include a software engine that employs predictive analytics in order to identify potential problems with an existing ITP for a construction project. For instance, this software engine may function to evaluate information regarding the progress and status of the construction project (to the extent available), make a prediction as to whether any due date in the ITP is at risk of not being met, and then if so, generate an alert that may be presented to a user such as an ITP manager. This software engine may perform various other operations as well.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions of the present disclosure.

FIG. 3A depicts an example snapshot of an interface that may be presented to a user in accordance with one embodiment.

FIG. 3B depicts an example snapshot of an interface that may be presented to a user in accordance with one embodiment.

FIG. 4A depicts an example snapshot of an interface that may be presented to a user in accordance with one embodiment.

FIG. 4B depicts an example snapshot of an interface that may be presented to a user in accordance with one embodiment.

FIG. 4C depicts an example snapshot of an interface that may be presented to a user in accordance with one embodiment.

FIG. 4D depicts an example snapshot of an interface that may be presented to a user in accordance with one embodiment.

FIG. 4E depicts an example snapshot of an interface that may be presented to a user in accordance with one embodiment.

FIG. 4F depicts an example snapshot of an interface that may be presented to a user in accordance with one embodiment.

FIG. 4G depicts an example snapshot of an interface that may be presented to a user in accordance with one embodiment.

FIG. 5 is a flow diagram depicting example operations for generating a two-dimensional technical drawing at a custom clip height, according to one embodiment of the present disclosure.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example System Configuration

As described above, the present disclosure is generally directed to an interactive software tool for facilitating the creation, management, and tracking of an ITP for a construction project, which may be referred to as an “ITP software tool.” The disclosed ITP software tool may be embodied in various manners. For instance, as one possibility, the disclosed ITP software tool may be integrated into a software as a service (“SaaS”) application for assisting with construction management, which may include a front-end software component that runs on a user's client station and a back-end software component that runs on a back-end platform accessible to the user's client station via a communication network such as the Internet. As another possibility, the disclosed ITP software tool may be integrated into a native application that runs on a user's client station. The disclosed ITP software tool may be embodied in other manners as well.

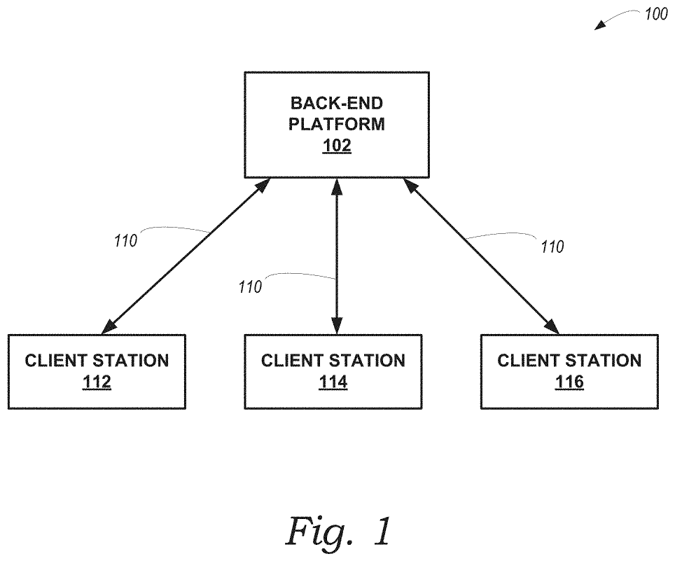

Turning now to the figures, FIG. 1 depicts an example network configuration 100 in which example embodiments of the present disclosure may be implemented. As shown in FIG. 1, network configuration 100 includes a back-end platform 102 that may be communicatively coupled to one or more client stations, depicted here, for the sake of discussion, as three client stations 112, 114, and 116.

In general, back-end platform 102 may comprise one or more computing systems that have been provisioned with software for carrying out one or more of the platform functions disclosed herein for driving a construction management SaaS application, including but not limited to functions related to establishing a connection between different accounts for a construction management SaaS application and/or enabling data records to be mirrored across connected accounts. The one or more computing systems of back-end platform 102 may take various forms and be arranged in various manners.

For instance, as one possibility, back-end platform 102 may comprise computing infrastructure of a public, private, and/or hybrid cloud (e.g., computing and/or storage clusters) that has been provisioned with software for carrying out one or more of the platform functions disclosed herein. In this respect, the entity that owns and operates back-end platform 102 may either supply its own cloud infrastructure or may obtain the cloud infrastructure from a third-party provider of “on demand” computing resources, such include Amazon Web Services (AWS) or the like. As another possibility, back-end platform 102 may comprise one or more dedicated servers that have been provisioned with software for carrying out one or more of the platform functions disclosed herein. Other implementations of back-end platform 102 are possible as well.

In turn, client stations 112, 114, 116 may take any of various forms, examples of which may include a desktop computer, a laptop, a netbook, a tablet, a smartphone, and/or a personal digital assistant (PDA), among other possibilities.

As further depicted in FIG. 1, back-end platform 102 is configured to interact with one or more client stations 112, 114, 116 over respective communication paths. Each communication path between back-end platform 102 and one of client stations 112, 114, 116 may generally comprise one or more communication networks and/or communications links, which may take any of various forms. For instance, each respective communication path with back-end platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path with back-end platform 102 may be wireless, wired, or some combination thereof, and may carry data according to any of various different communication protocols. Although not shown, the respective communication paths with back-end platform 102 may also include one or more intermediate systems. For example, it is possible that back-end platform 102 may communicate with a given client station 112, 114, 116 via one or more intermediary systems, such as a host server (not shown). Many other configurations are also possible.

Although not shown in FIG. 1, back-end platform 102 may also be configured to receive data from one or more external data sources that may be used to facilitate functions related to the disclosed process. A given external data source—and the data output by such data sources—may take various forms.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. Example Platform

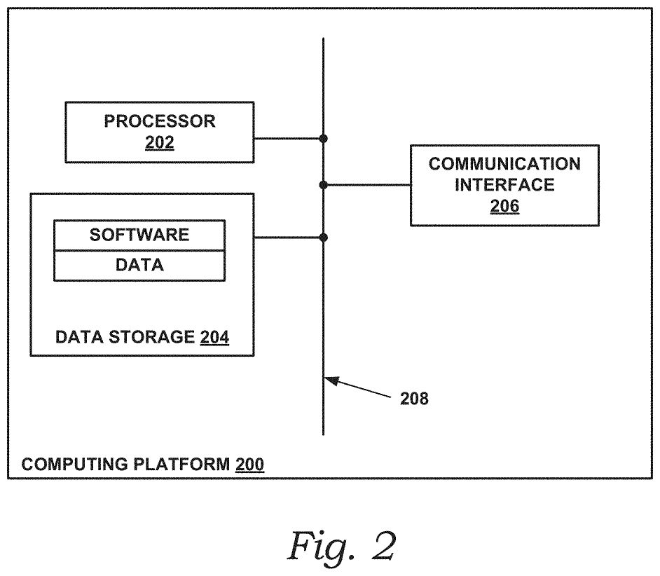

FIG. 2 is a simplified block diagram illustrating some structural components that may be included in an example computing platform 200, which could serve as back-end platform 102 of FIG. 1. In line with the discussion above, platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

Processor 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 202 could comprise processing components that are distributed across a plurality of physical computing devices connected via a network, such as a computing cluster of a public, private, or hybrid cloud.

In turn, data storage 204 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 204 may comprise computer-readable storage mediums that are distributed across a plurality of physical computing devices connected via a network, such as a storage cluster of a public, private, or hybrid cloud.

As shown in FIG. 2, data storage 204 may be provisioned with software components that enable the platform 200 to carry out the platform-side functions disclosed herein. These software components may generally take the form of program instructions that are executable by the processor 202 to carry out the disclosed functions, which may be arranged together into software applications, virtual machines, software development kits, toolsets, or the like. Further, data storage 204 may be arranged to store data in one or more databases, file systems, or the like. Data storage 204 may take other forms and/or store data in other manners as well.

Communication interface 206 may be configured to facilitate wireless and/or wired communication with external data sources and/or client stations, such as client stations 112, 114, 116 in FIG. 1. Additionally, in an implementation where platform 200 comprises a plurality of physical computing devices connected via a network, communication interface 206 may be configured to facilitate wireless and/or wired communication between these physical computing devices (e.g., between computing and storage clusters in a cloud network). As such, communication interface 206 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wireless and/or wired communication. Communication interface 206 may also include multiple communication interfaces of different types. Other configurations are possible as well.

Although not shown, platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with platform 200.

It should be understood that platform 200 is one example of a computing platform that may be used with the embodiments described herein. Numerous other arrangements are possible and contemplated herein. For instance, other computing platforms may include additional components not pictured and/or more or less of the pictured components.

### III. ITP Software Tool

As discussed above, disclosed herein is an interactive software tool for facilitating the creation, management, and tracking of an ITP for a construction project, which may be referred to as an “ITP software tool.” The disclosed ITP software tool may include various aspects and take various forms.

In one aspect, the disclosed ITP software tool may provide a first interface through which users can create a new ITP for a construction project. This first interface—and the manner in which ITPs may be created via this first interface—may take various forms.

For instance, the first interface may provide a user with the ability to define general information for a new ITP for a construction project, such as a name of the ITP, a type of work to which the ITP relates (e.g., concrete), a textual description of the ITP, and/or a particular manager of the ITP, among other examples.

Further, the first interface may provide a user with the ability to define, on an activity-by-activity basis, the inspection and test activities that are to be included in the ITP for the construction project. In this respect, the first interface may present a user with a variety of different fields that can be used to define a given inspection or test activity, examples of which may include a title of the given activity, a textual description of the given activity, a reference link to a particular specification that forms the basis for the given activity, a due date for the given activity, an identification of one or more individuals that are responsible for completing and closing out the given activity (referred to herein as “assignee(s)”), an indication of any “hold point condition” for the given activity (i.e., a condition specifying that certain other activities in the ITP are not to be performed until the given activity is closed out), and/or an indication of whether any particular record type(s) are required to evidence completion of the given activity, among other possibilities.

Further yet, in connection with providing a user with the ability to define the inspection and test activities that are to be included in the ITP for the construction project, the first interface may additionally provide the user with the ability to group and sequence the inspection and test activities in the ITP in various manners. For instance, the first interface may additionally provide the user with the ability to group certain inspection and test activities in the ITP together into different “sections” of the ITP, define a particular sequence for different sections of inspection and test activities, and/or define a particular sequence for inspection and test activities included within a particular section. In this respect, the grouping and/or sequencing of inspection and test activities in the ITP may provide an indication of the relationship between different inspection and test activities in the ITP (and perhaps also an indication of when certain inspection and activities are to be completed relative to one another).

Still further, the first interface may provide a user with the ability to define one or more users (referred to as “approver(s)”) whose sign-off is required to approve the ITP before the ITP can be published. For instance, the first interface may provide a text box within which a user may input one or more email addresses or other identifying information of a user that will act as an approver. In addition or as an alternative, the first interface may provide a drop-down box that provides a list of potential users that can act as approvers for the given ITP and via which the user may select one or more of such listed users in order to define such users as an approver. The first interface may provide a user with the ability to define one or more approvers in other ways as well.

Still further, the first interface may provide a user with the ability to define one or more users (referred to as “receiver(s)”) whose final sign-off is required to approve the final ITP once all necessary records evidencing completion of the defined activities have been uploaded and the ITP is desired to be completed and closed out. For instance, the first interface may provide a text box within which a user may input one or more email addresses or other identifying information of a user that will act as an receiver. In addition or as an alternative, the first interface may provide a drop-down box that provides a list of potential users that can act as receivers for the given ITP and via which the user may select one or more of such listed users in order to define such users as a receiver. The first interface may provide a user with the ability to define one or more receivers in other ways as well.

Still further, the first interface may provide a user with the ability to publish the ITP once the general information and the inspections and tests have been defined, which may cause the ITP software tool to finalize the ITP and make it available for use during the execution and/or closure phases of the construction project. As referenced above, prior to publishing the ITP, in some embodiments, the ITP may go through a template review process by which the completed ITP draft would be transmitted to the one or more users who were defined as ITP template approvers, in a manner that may be similar to that referenced above. In some implementations, an interface may be presented to each of these approvers that provides these approvers with the ability to approve the ITP template, decline to approve the ITP template, and/or suggest or make changes to the ITP template prior to approving the ITP template. Other template review processes are possible as well.

This first interface may take other forms and/or enable a user to perform other tasks related to the creation of an ITP for a construction project as well.

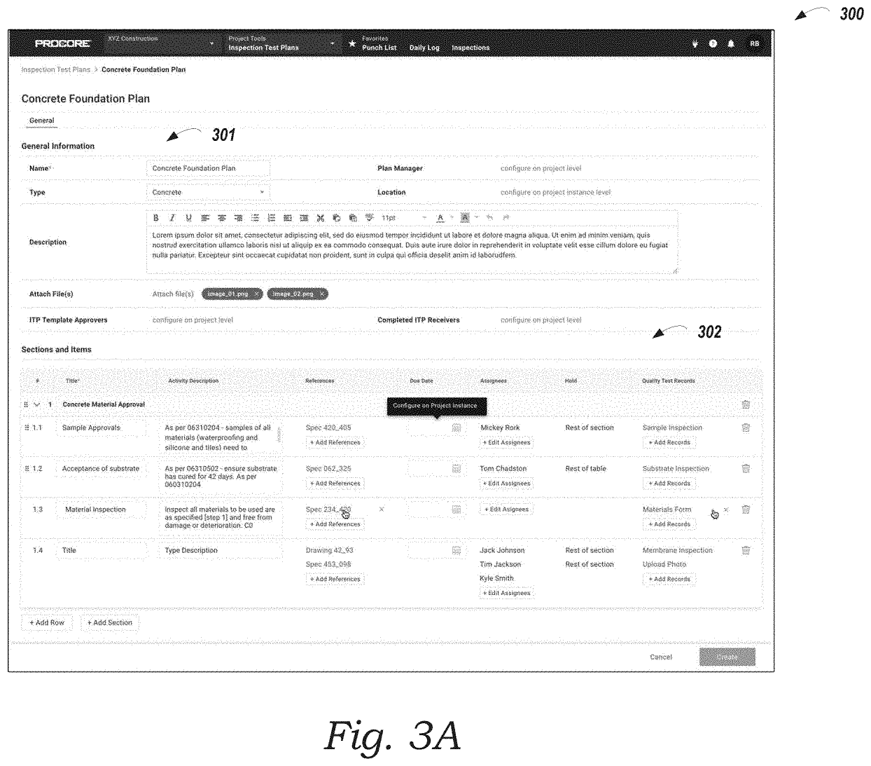

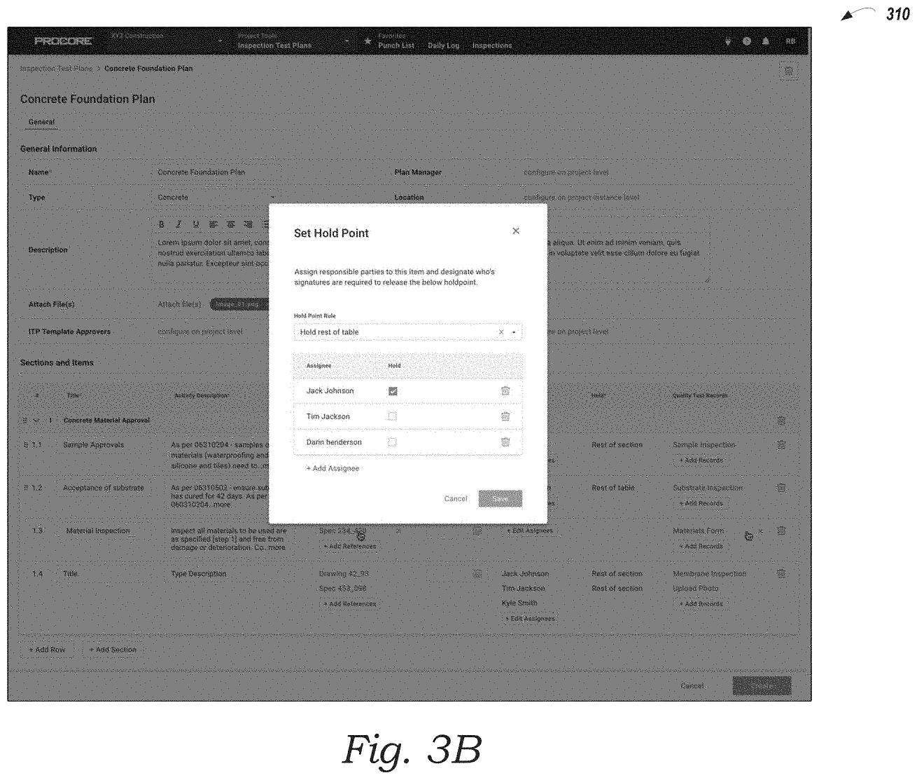

To help illustrate some of the features and functionality of the first interface provided by the disclosed ITP software tool, FIGS. 3A-B depict example snapshots 300 and 310, respectively. Turning first to snapshot 300 in FIG. 3A, this snapshot depicts an example of the first interface, which may be presented to a user to facilitate defining general information for a new ITP for a construction project. As depicted in snapshot 300, the interface may include a general information area 301 that provides various input elements, such as text boxes and drop-down boxes, that allow a user to input data defining, inter alia, the name of the ITP, a type of work to which the ITP relates (e.g., concrete), a textual description of the ITP, a particular manager of the ITP, upload files that further describe or otherwise assist in defining general information of the ITP, define a user as an approver of the template ITP, and/or define a user as a completed ITP receiver, among other examples.

The interface may also include a sections and items area 302 that provides various text boxes, drop-down boxes, and/or weblinks that allow a user to input data defining, inter alia, a title of the given activity, a textual description of the given activity, a reference link to a particular specification that forms the basis for the given activity, a due date for the given activity, an identification of one or more individuals that are responsible for completing and closing out the given activity (referred to herein as “assignee(s)”), an indication of any “hold point condition” for the given activity (i.e., a condition specifying that certain other activities in the ITP are not to be performed until the given activity is closed out), and/or an indication of whether any particular record type(s) are required to evidence completion of the given activity, among other possibilities.

The sections and items area 302 may additionally include one or more buttons, weblinks, or other mechanisms for adding or changing the assignee(s) and/or the hold point condition that are assigned to a particular activity specified in the sections and items area. As depicted in snapshot 300 for instance, the interface may include an “Edit Assignees” button for each activity specified in the sections and items areas 302. When an “Edit Assignees” button for a given activity is clicked (or otherwise selected), the interface may be operable to display a pop-up window or the like within which the user may add or change the assignees and/or the hold point condition for the given activity. Snapshot 310 in FIG. 3B depicts an example pop-window that may be displayed by the first interface responsive to receiving a user input selecting the “Edit Assignees” button for a given activity. As depicted, the pop-up window may include a hold point rule drop down box that contains various options for defining a hold point rule for the given activity. As mentioned above, for instance, the various types of hold point rules may include a “Rest of Table” hold point condition and a “Rest of Section” hold point condition, among other possible types of hold point conditions. As further depicted, the pop-up window may also include a section for adding or changing the assignees of the given activity and assigning a hold point to a particular assignee. Assigning a particular hold point condition to a given assignee may operate to instruct the ITP software tool to require that given assignee's sign-off in order to release the hold point. For instance, as depicted in snapshot 310, a user may have clicked (or otherwise selected) a check box associated with the assignee “Jack Johnson,” which may operate to instruct the ITP software tool to require that the “Jack Johnson” assignee sign-off on the given activity before the “Rest of Table” hold point condition for the given activity is released. As still further depicted, the pop-up window may include additional input elements (such as a trash can icon or a “Add Assignee” button, which when clicked (or otherwise selected) may operate to delete a given assignee from the given activity or add a new assignee to the given activity, respectively. Other ways to add or change assignees and to specify hold conditions may be possible as well.

It should be appreciated that the particular arrangement and/or implementation of the first interface as depicted in FIGS. 3A and 3B is merely exemplary, and in practice the first interface may include, more or fewer input elements, one or more different types of input elements, and/or a different arrangement of input elements, among other possible differences.

In another aspect, the disclosed ITP software tool may include a software engine that functions to automatically define inspection and test activities for inclusion in the ITP. For instance, such a software engine may function to evaluate specifications associated with a construction project (e.g., by searching for relevant terms like “quality” or “inspection”), and then based on that evaluation, automatically define one or more inspection and test activities for inclusion in the ITP. In this respect, the disclosed ITP software tool either may automatically add the inspection and test activities that are defined by the software engine to the ITP or may present a user with an opportunity to approve, reject, and/or modify the inspection and test activities that are defined by the software engine before they are added to the ITP.

Along similar lines, the software engine may also be capable of detecting a change to a specification associated with a construction project after the ITP for the construction project has been published and then automatically updating certain inspection and test activities in ITP in accordance with the detected changed to the specification.

In yet another aspect, the disclosed ITP software tool may provide a second interface through which users can manage and track the status of an existing ITP for a construction project. This second interface—and the manner in which ITPs may be managed and tracked via this second interface—may take various forms.

For instance, as an initial matter, the second interface may present a user with general information for the ITP and the set of inspections and tests included in the ITP. In this respect, the presentation of the set of inspections and tests may include some or all of the defining information for the inspection and test activities, including but not limited to the titles of the activities, textual descriptions of the activities, reference links to particular specifications that form the basis for the activities, due dates for the activities, assignees for the activities, hold point conditions for the activities, and/or indications of required record types for the activities, among other possibilities.

Further, the second interface may present a user with the ability to link a record to a given inspection or test activity that evidences completion of the given activity. For example, if the defining information for a given inspection or test activity includes an indication that a record of a given type needs to be provided in order to close out the given activity, the second interface may present that indication in the form of text having an embedded link, which a user can click (or otherwise select) in order to launch a workflow for linking a record of the given type to the given activity. As another example, the second interface may present a selectable “Add Records” button for a given inspection or test activity, which a user can click (or otherwise select) in order to launch a workflow for linking records of various types to the given activity. The second interface may enable a user to link a record to a given inspection or test activity in other manners as well. After receiving a user's request to link a given record to a given inspection or test activity, the ITP tool may update the presentation of the inspections and tests included in the ITP to indicate that the record has been linked to the given activity.

Further yet, the second interface may present each assignee of a given inspection or test activity with the ability to sign off on completion of the given activity. For example, as part of presenting the defining information for a given inspection or test in the ITP, the second interface may present an assignee's name in the form of a text having an embedded link, which a user can click (or otherwise select) in order to launch a workflow that enables the assignee to sign off on completion of the given activity by inputting the assignee's name and electronic signature. However, the second interface may enable a user to sign off on completion of a given inspection or test activity in other manners as well. After receiving an assignee's sign-off information for the given activity, the ITP tool may then validate the sign-off information, and then if that validation is successful, the ITP tool may update the presentation of the inspections and tests included in the ITP to indicate that the assignee has successfully signed off on the given activity.

Still further, to the extent that the defining information for the inspection and test activities in the ITP include hold point conditions, the second interface may use these hold point conditions along with the grouping and/or sequencing of the ITP as a basis for placing conditional restrictions on a user's ability to interact with certain inspection and test activities in the ITP (e.g., by “locking” such activities so that a user cannot link records or sign off on completion).

For example, a given inspection or test activity may have a “Rest of Plan” hold point condition, which is a condition dictating that no activities sequenced after the given activity in the ITP are to be performed until the given activity is closed out, in which case the second interface may restrict a user's ability to interact with any successive activity in the ITP unless and until the given activity is closed out. As another example, a given inspection or test activity may have a “Rest of Section” hold point condition, which is a condition dictating that no activities sequenced after the given activity in a particular section of the ITP are to be performed until the given activity is closed out, in which case the second interface may restrict a user's ability to interact with any successive activity in the particular section of the ITP unless and until the given activity is closed out. Other examples are possible as well.

For a given inspection or test activity that has such a hold point condition, the disclosed ITP software tool may then keep track of whether the given activity has met the necessary criteria to be closed out, which may take various forms. As one possibility, such criteria may look at (a) whether each required record type (or at least one record of any type, if no particular record type is specified) has been linked to the given activity to evidence completion and (b) whether each required assignee has signed off on the completion of the given activity. As another possibility, such criteria may look at not only whether each required record type has been linked to the given activity to evidence completion, but also whether the content of the linked record(s) are sufficient to evidence completion of the given activity. The criteria used to determine whether an inspection or test activity has been closed out may take various other forms as well.

In turn, once it is determined that the given activity has met the necessary criteria to be closed out, the disclosed ITP software tool may then release the restriction on a user's ability to interact with one or more successive activities for which user interaction was previously restricted based on the given activity's hold point condition. In this respect, the disclosed ITP software tool may determine which of the successive activities in the ITP are to be “unlocked” and which of the successive activities in the ITP are to remain “locked” based on the grouping and/or sequencing of the ITP, the particular type of hold point condition defined for the given activity, and the existence of hold point conditions for any of the successive activities in the ITP.

For example, if a first activity in the ITP's sequence has a “Rest of Plan” hold point condition, then closing out the first activity may cause the disclosed ITP software tool to unlock every successive activity in the ITP's sequence up to and including the next successive activity that has a hold point condition. In this respect, if the next successive activity having a hold point condition is the second activity in the ITP's sequence, the disclosed ITP software tool may only unlock the second activity (while keeping all other successive activities locked pending close out of the second activity), whereas if the next successive activity having a hold point condition is the third activity in the ITP's sequence, the disclosed ITP software tool may unlock the second and third activities (while keeping all other successive activities locked pending close out of the third activity), and so on.

As another example, if a first activity in a section of the ITP has a “Rest of Section” hold point condition, then closing out the first activity may cause the disclosed ITP software tool to unlock every successive activity in the section up to and including the next successive activity in the section having a hold point condition. In this respect, if the next successive activity in the section having a hold point condition is the second activity in the section's sequence, the disclosed ITP software tool may only unlock the second activity (while keeping all other successive activities in the section locked pending close out of the second activity), whereas if the next successive activity in the section having a hold point condition is the third activity in the section's sequence, the disclosed ITP software tool may unlock the second and third activities (while keeping all other successive activities in the section locked pending close out of the third activity), and so on.

This second interface may take other forms and/or enable a user to perform other tasks related to the management and tracking of an ITP for a construction project as well.

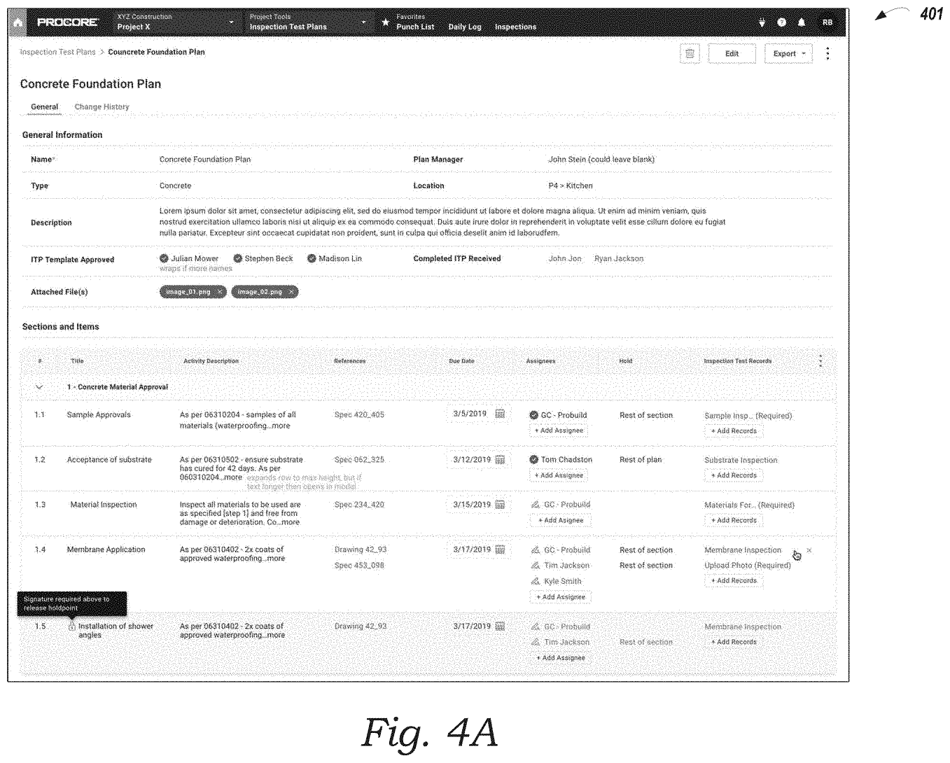

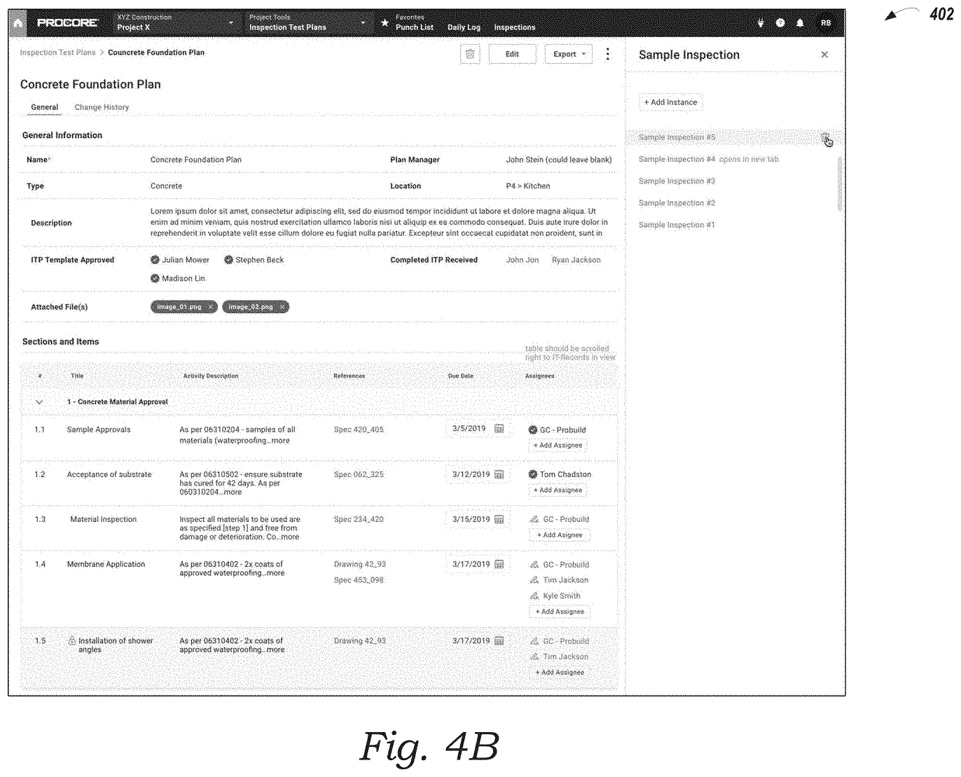

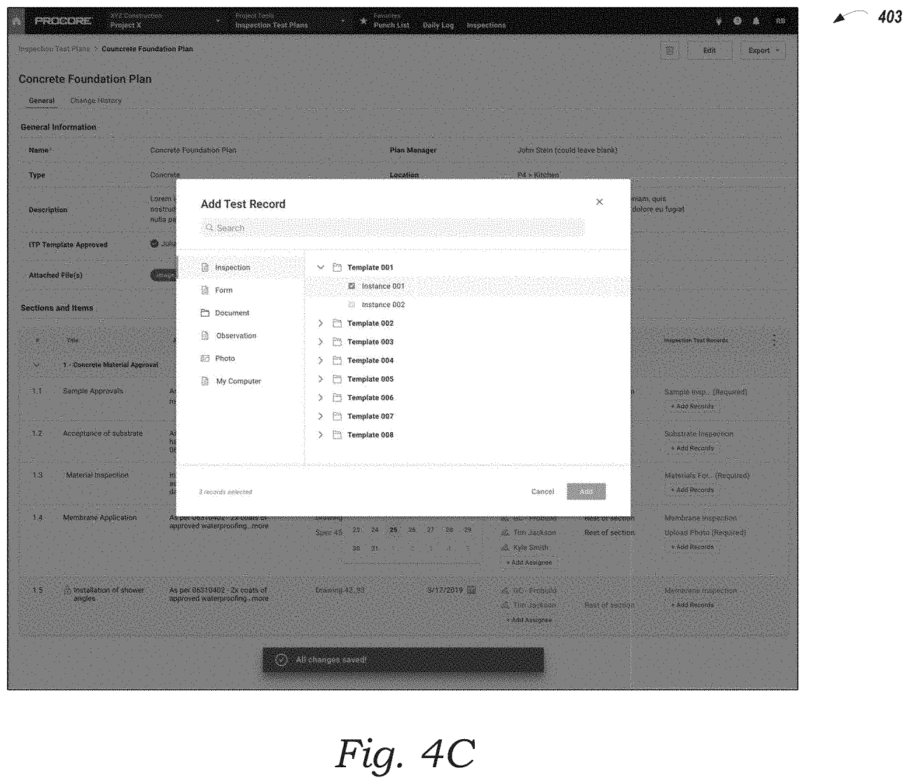

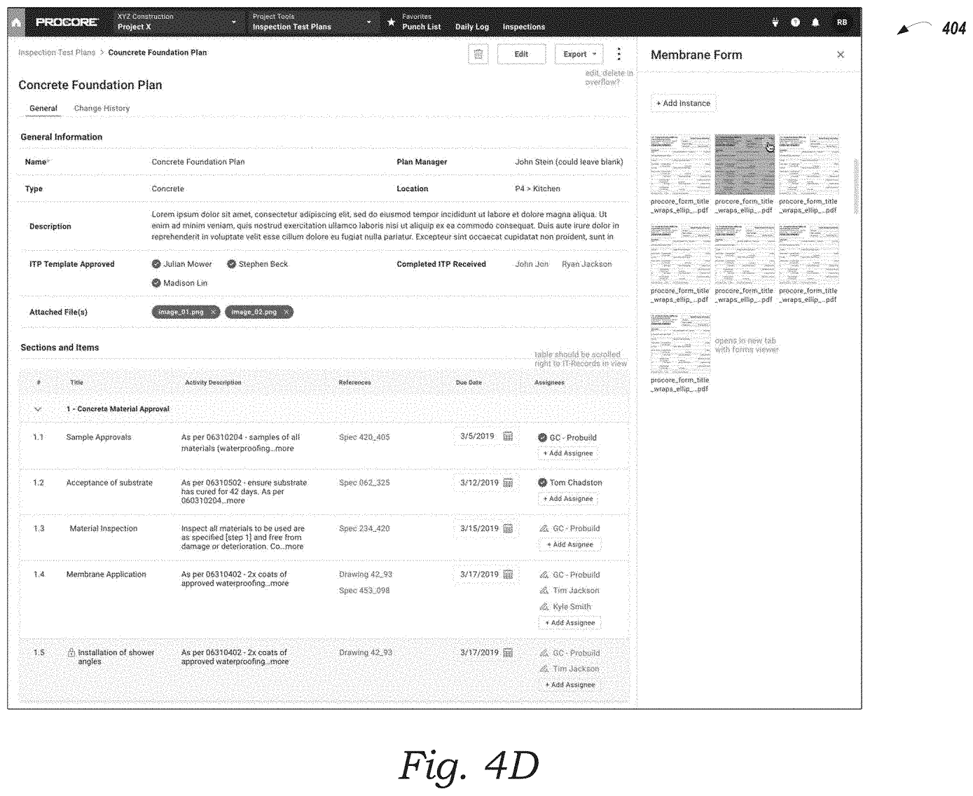

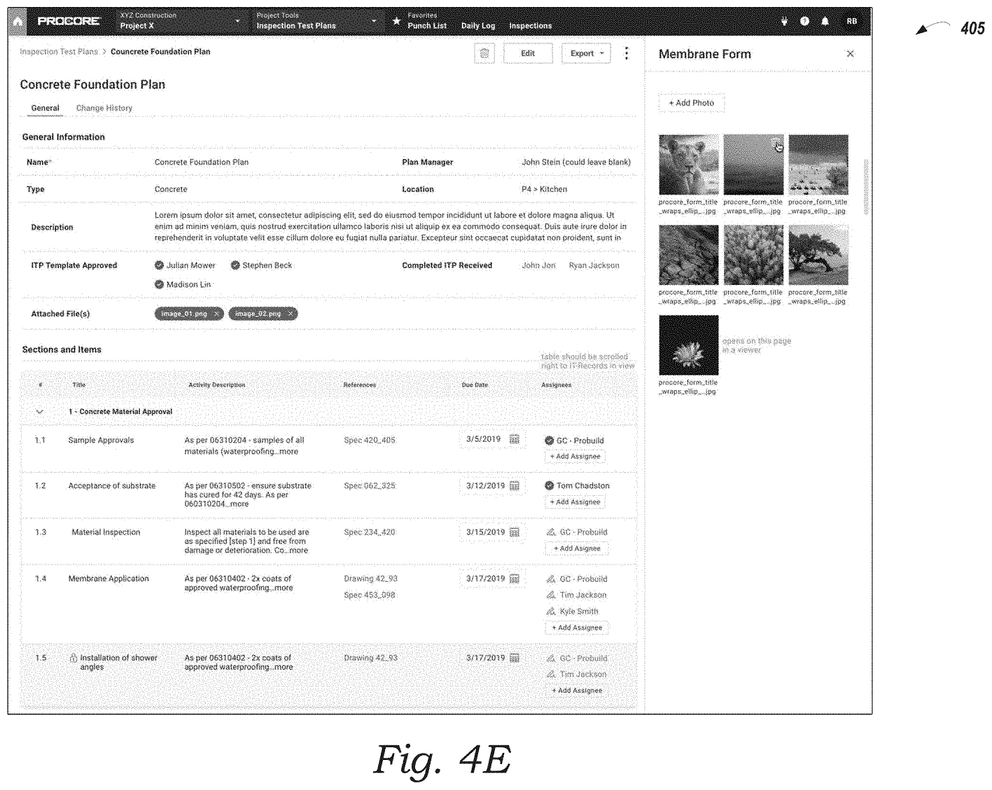

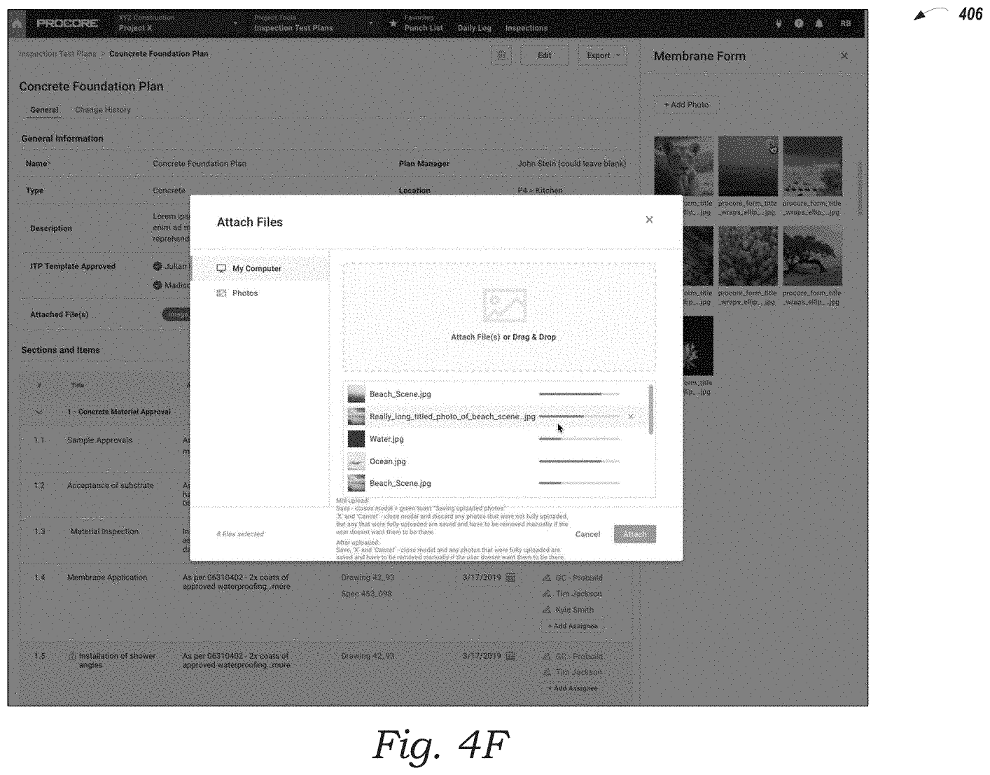

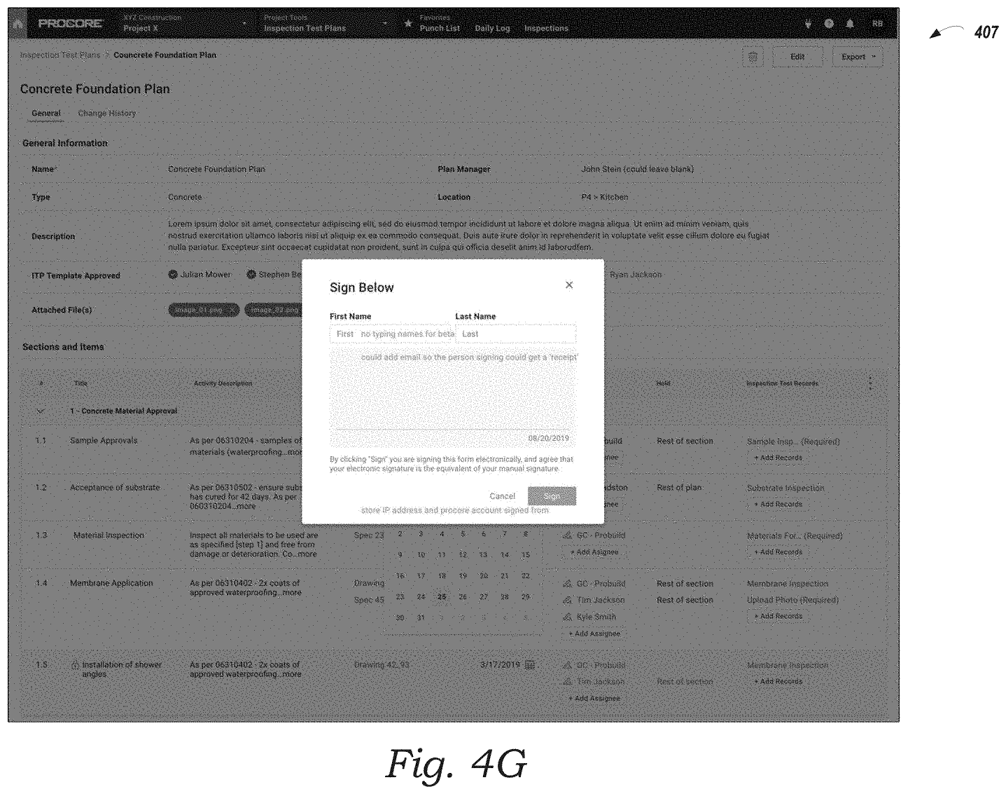

To help illustrate some of the features and functionality of the second interface provided by the disclosed ITP software tool, FIGS. 4A-G depict example snapshots 401-407, respectively. Turning first to snapshot 401 in FIG. 4A, this snapshot depicts an example of the second interface, through which users can manage and track the status an existing ITP for a construction project. As depicted, snapshot 401 shows an example of the second interface as it may be used in connection with the same example ITP defined as set forth in the example above with respect to FIGS. 3A-B. In particular, snapshot 401 depicts a general information area that may present a user with the general information for the ITP, and a sections and items area that may present the user with the set of inspections and tests included in the ITP. As depicted in this example, the presentation of the set of inspections and tests include defining information for the inspection and test activities, such as the titles of the activities, textual descriptions of the activities, reference links to particular specifications that form the basis for the activities, due dates for the activities, assignees for the activities, hold point conditions for the activities, and/or indications of required record types for the activities, although other types of defining information are possible in other examples.

As explained above, the second interface may present a user with the ability to link a record to a given inspection or test activity that evidences completion of the given activity. The second interface may present the user with this ability in a variety of different ways. As one possibility, for instance, if the defining information for a given inspection or test activity includes an indication that a record of a given type needs to be provided in order to close out the given activity, the second interface may present that indication in the form of text having an embedded link, which a user can click (or otherwise select) in order to launch a workflow for linking a record of the given type to the given activity. To illustrate this, as indicated in the example interface depicted in snapshot 401, the first item (“Sample Approvals”) presented in the list of items in the sections and items area has an embedded link in the “Inspection Test Records” column, namely a “Sample Inspection,” link. This link, when clicked (or otherwise selected) by the user may operate to present a listing of records that have been uploaded (or otherwise input into the ITP software tool) for the “Sample Approvals” activity.

For instance, snapshot 402 in FIG. 4B depicts an example “Sample Inspection” frame that is presented in the right-hand side of the second interface, which the ITP software tool may present in response to receiving a user input selecting the “Sample Inspection” embedded link in the “Inspection Test Records” column. As depicted, the interface presents various sample inspections that may have been uploaded by a user for the “Sample Approvals” item. These sample inspection items may each comprise an embedded link, which when clicked (or otherwise selected) by the user may operate to further display additional details concerning the sample inspections. Other ways to present records for a given inspection or test activity may be possible as well.

As another possibility, the second interface may present a selectable “Add Records” button for a given inspection or test activity, which a user can click (or otherwise select) in order to launch a workflow for linking records of various types to the given activity. For example, when clicked (or otherwise selected), the second interface may present a pop-up window through which a user may provide various user inputs in order to input a new record into the ITP software tool, such as the example pop-up window depicted in snapshot 403 of FIG. 4C. As depicted in snapshot 403, the pop-up window includes the ability to select from various pre-defined templates of inspection records, provide data through a form, upload a document (such as a .PDF or .DOCX file format document, among other possible file types), provide a descriptive observation, upload a photo, and/or browse “My Computer” to upload a different type of file. The interface may allow a user to upload or otherwise provide new records in other ways as well.

The second interface may also present a user with the ability to view records that have already been uploaded for a given inspection or test activity that evidences completion of the given activity. For instance, returning to snapshot 401 in FIG. 4A, example item 1.4 “Membrane Application” may have a corresponding “Membrane Inspection” indication presented in the form of an embedded link in the “Inspection Test Records” column. When clicked (or otherwise selected), the second interface may present various membrane inspection records that have been previously uploaded. Snapshot 404 in FIG. 4D depicts one example of this, where, for instance, the second interface may display a “Membrane Form” frame in the right-hand side of the interface. In this frame, the second interface may present selectable indications of records that may have been previously uploaded. When clicked (or otherwise selected), the second interface may display the record or download it to the user's computing device. Other ways to present previously uploaded records may be possible as well.

As another example of presenting the user with the ability to view records that have already been uploaded for a given inspection or test activity, the second interface may include an “Upload Photo” embedded link, or the like, such as the “Upload Photo (Required)” embedded link presented in the “Inspection Test Records” column, as depicted in snapshot 401 of FIG. 4A. When clicked (or otherwise selected), the second interface may present various photos that may have been uploaded for the given inspection or test activity, as is depicted in snapshot 405 of FIG. 4E. As depicted, the second interface may display a “Membrane Form” frame in the right-hand side of the interface, which presents selectable indications of photos that may have been previously uploaded. When clicked (or otherwise selected), the second interface may display the photo or download it to the user's computing device. In addition, the second interface may present a selectable “Add Photo” button which when selected may operate to present a prompt that allows the user to upload a new photo, as is depicted in snapshot 406 in FIG. 4F. For instance, as depicted in snapshot 406, the second interface may, upon receiving a user input selecting the “Add Photo” button, present the “Attach Files” pop-up window, which prompts the user to attach a photo or drag and drop a photo onto the pop-up window in order to upload the photo to the ITP software tool. Other ways to present previously uploaded records and to present prompts allowing users to upload new records may be possible as well.

As also explained above, the second interface may present each assignee of a given inspection or test activity with the ability to sign off on completion of the given activity. For example, as part of presenting the defining information for a given inspection or test in the ITP, the second interface may present an assignee's name in the form of a text having an embedded link, which a user can click (or otherwise select) in order to launch a workflow that enables the assignee to sign off on completion of the given activity by inputting the assignee's name and electronic signature. An example of this is depicted in snapshot 407 of FIG. 4H which depicts a “Sign Below” pop-up window that may be displayed by the second interface responsive to receiving a user input selecting the embedded link in the form of the assignee's name. As depicted, the “Sign Below” pop-up window includes various text boxes in which a user may enter his or her first name, last name, and/or other information, such as an email address or a text description of the user's title and a “Sign” button, which when selected may operate to instruct the ITP software tool that the user has signed off on completion of a given inspection or test activity. After receiving the sign-off information for the given activity, the ITP software tool may then validate the sign-off information, and if that validation is successful, the ITP tool may update the presentation of the inspections and tests included in the ITP to indicate that the assignee has successfully signed off on the given activity. Other ways of presenting assignees of a given inspection or test activity with the ability to sign off on completion of the given activity are possible as well.

In still another aspect, the disclosed ITP software tool may include a software engine that employs predictive analytics in order to identify potential problems with an existing ITP for a construction project. For instance, this software engine may function to evaluate information regarding the progress and status of the construction project (to the extent available), make a prediction as to whether any due date in the ITP is at risk of not being met, and then if so, generate an alert that may be presented to a user such as an ITP manager. As another example, this software engine may function to evaluate information regarding the progress and status of the construction project (to the extent available) as well as historic data concerning other ITP submissions, and make a prediction so as to help users forecast how much time a given ITP may take to complete. This software engine may perform various other operations as well, including providing various reporting features and functionality in order to generate textual and/or visual indications of various metrics of a given ITP, among other possibilities.

### IV. Example Operations

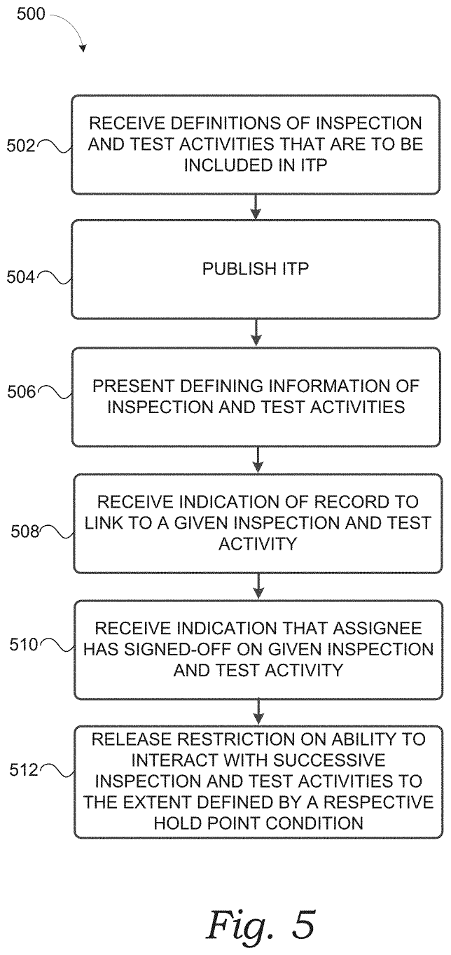

To further illustrate an example workflow, in accordance with one or more embodiments of the present ITP software tool, reference will now be made to flow diagram 500 of FIG. 5, which depicts an example process carried out in accordance with an embodiment of the disclosed software tool. Example operations depicted by the various blocks of flow diagram 500 may be carried out by one or more computing devices running the disclosed software tool. For purposes of illustration only, these example operations may be described as being carried out by the disclosed software tool, which may take the form of a computing device running the disclosed software tool carrying out the example operations, such as computing device 200 (FIG. 2), which as described above, may serve as one or more of client stations 112 (FIG. 1) and/or back-end platform 102 (FIG. 1). In this respect, it should be understood that, depending on the implementation, the operations discussed herein below may be carried out entirely by a single computing device, such as one or more of client stations 112 or by back-end platform 102, or may be carried out by a combination of computing devices, with some operations being carried out by back-end platform 102 (such as computational processes and data-access operations) and other operations being carried out by one or more of client stations 112 (such as display operations and operations that receive user inputs). However, other arrangements are possible as well.

Further, depending on the implementation, a block in a flow diagram may represent a module or portion of program code that includes instructions that are executable by a processor to implement specific logical functions or steps in a process. The program code may be stored on any type of computer-readable medium, such as non-transitory computer readable media (e.g., data storage 204 (FIG. 2)). In other cases, a block in a flow diagram may represent circuitry that is wired to perform specific logical functions or steps in a process. Moreover, the blocks shown in the flow diagrams may be rearranged into different orders, combined into fewer blocks, separated into additional blocks, and/or removed, based upon the particular embodiment. A flow diagram may also be modified to include additional blocks that represent other functionality that is described expressly or implicitly elsewhere herein.

Turning first to block 502, the ITP software tool may receive definitions of inspection and test activities that are to be included in an ITP for a construction project. As described above, this may take the form of the ITP software tool receiving defining information for one or more inspection or test activities, examples of which may include a title of the given activity, a textual description of the given activity, a reference link to a particular specification that forms the basis for the given activity, a due date for the given activity, an identification of one or more individuals that are responsible for completing and closing out the given activity (i.e., assignees), an indication of any “hold point condition” for the given activity (i.e., a condition specifying that certain other activities in the ITP are not to be performed until the given activity is closed out), an indication of whether any particular record type(s) are required to evidence completion of the given activity, among other possibilities, and/or information indicting any grouping or sequencing of the inspection and test activities. The ITP software tool may receive this information through an appropriate user interface, such as one or more of the interfaces presented in snapshots 300 and 310 of FIGS. 3A-B. Other ways to receive definitions of inspection and test activities are possible as well.

Next at block 504, the ITP software tool may publish the ITP once the general information and the inspections and tests have been received at block 502. Publishing the ITP may take the form of the ITP software tool finalizing the ITP and making it available for use during the execution and/or closure phases of the construction project. For instance, once a given ITP is published, assignees, or other individuals that may need or desire to review the information contained within the ITP, may have the ability to review the ITP via a user interface presenting a corresponding instance of the ITP software tool. Other examples of publishing the ITP are possible as well.

As mentioned, in some embodiments, prior to publishing the ITP, the software tool may engage in a template review process by which the software tool may transmit the completed ITP draft to the one or more users who were defined as ITP template approvers, in a manner similar to that referenced above. In some implementations, the software tool may present an interface to each of these approvers that provides these approvers with the ability to approve the ITP template, decline to approve the ITP template, and/or suggest or make changes to the ITP template prior to approving the ITP template. Other template review processes are possible as well.

Next at block 506, the ITP software tool may present (or cause to be presented) defining information of the inspection and test activities. The ITP software tool may facilitate this by presenting an interface to an assignee (or other individual that desires to review the ITP) of a respective inspection or test activity, where such interface includes the various defining information of the inspection and test activities. Such an interface may take the form of the interface depicted in snapshot 401, although other interfaces are possible.

Next at block 508, the ITP software tool may receive an indication of a record to link to a given inspection and test activity. As described above, the ITP software tool may present an interface, such as the interfaces depicted in snapshots 402-406 in FIGS. 4B-F, which provides a user with the ability to link a record to a given inspection or test activity that evidences completion of the given activity. As one example of this, if the defining information for a given inspection or test activity includes an indication that a record of a given type needs to be provided in order to close out the given activity, the ITP software tool may present that indication in the form of text having an embedded link, which a user can click (or otherwise select) in order to launch a workflow for linking a record of the given type to the given activity. As another example, the ITP software tool may present a selectable “Add Records” button for a given inspection or test activity, which a user can click (or otherwise select) in order to launch a workflow for linking records of various types to the given activity. The ITP software tool may receive an indication of a record to link to a given inspection and test activity in other manners as well. As further indicated above, after receiving a user's request to link a given record to a given inspection or test activity, the ITP software tool may update the presentation of the inspections and tests included in the ITP to indicate that the record has been linked to the given activity.

Next at block 510, the ITP software tool may receive an indication that that an assignee as signed-off on a given inspection and test activity. As described above, the ITP software tool may for example, as part of presenting the defining information for a given inspection or test in the ITP, present an interface (such as the interface depicted in snapshot 401 in FIG. 4A) that may present an assignee's name in the form of a text having an embedded link, which a user can click (or otherwise select) in order to launch a workflow that enables the assignee to sign off on completion of the given activity by inputting the assignee's name and electronic signature. The ITP software tool may, upon receiving an indication that the user has clicked (or otherwise selected) the embedded link, present an interface, such as the interface depicted in snapshot 407 of FIG. 4G, through which a user may sign off on a given inspection and test activity. Other ways to receive an indication that that an assignee as signed-off on a given inspection and test activity.

Next at block 512, the ITP software tool may release any restriction on the ability to interact with successive inspection and test activities to the extent defined by a respective hold point condition. For instance, as described above, a given inspection and test activity may have a hold point condition that acts as a basis for placing conditional restrictions on a user's ability to interact with the given inspection and test activity in the ITP (e.g., by “locking” such activities so that a user cannot link records or sign off on completion). As one example, a given inspection or test activity may have a “Rest of Plan” hold point condition, which is a condition dictating that no activities sequenced after the given activity in the ITP are to be performed until the given activity is closed out, in which case the second interface may restrict a user's ability to interact with any successive activity in the ITP unless and until the given activity is closed out. As another example, a given inspection or test activity may have a “Rest of Section” hold point condition, which is a condition dictating that no activities sequenced after the given activity in a particular section of the ITP are to be performed until the given activity is closed out, in which case the second interface may restrict a user's ability to interact with any successive activity in the particular section of the ITP unless and until the given activity is closed out. Other examples are possible as well.

The ITP software tool may release any restriction on the ability to interact with successive inspection and test activities to the extent defined by a respective hold point condition by looking at (a) whether each required record type has been linked to the given activity to evidence completion and (b) whether each required assignee has signed off on the completion of the given activity. As another possibility, such criteria may look at not only whether each required record type has been linked to the given activity to evidence completion, but also whether the content of the linked record(s) are sufficient to evidence completion of the given activity. Once it is determined that the given activity has met the necessary criteria to be closed out, the disclosed ITP software tool may then release the restriction on a user's ability to interact with one or more successive activities for which user interaction was previously restricted based on the given activity's hold point condition. In this respect, the disclosed ITP software tool may determine which of the successive activities in the ITP are to be “unlocked” and which of the successive activities in the ITP are to remain “locked” based on the grouping and/or sequencing of the ITP, the particular type of hold point condition defined for the given activity, and the existence of hold point conditions for any of the successive activities in the ITP. The ITP software tool may release any restriction on the ability to interact with successive inspection and test activities in other ways as well.

One each inspection and test activity has been completed, the software tool may provide a final sign-off process by which an indication that the entire ITP is ready to be finalized and signed-off on may be transmitted to the one or more users who were defined as completed ITP receivers above. To facilitate this, in some implementations, an interface may be presented to each of these receivers that provides these receivers with the ability to approve all submissions of records for the ITP, decline to approve any part of the ITP, and/or suggest or make changes to the ITP prior to finalizing and signing-off on the ITP. Other review processes are possible as well.

### V. Conclusion

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “users” or other entities, this is for purposes of example and explanation only. Claims should not be construed as requiring action by such actors unless explicitly recited in claim language.

1. A computing system comprising:
at least one processor;
a non-transitory computer-readable medium; and
program instructions stored on the non-transitory computer-readable medium that are executable by the at least one processor such that the computing system is configured to:
receive definitions of a plurality of inspection and test activities that are to be included in an inspection and test plan (ITP) for a construction project;
publish the ITP by making the ITP available to at least one assignee;
present the definitions of the plurality of inspection and test activities to the at least one assignee;
receive an indication of a record to link to a first inspection and test activity of the plurality;
receive an indication that at least one assignee has signed-off on the first inspection and test activity; and
in response to receiving the indication that at least one assignee has signed-off on the first inspection and test activity, release a restriction on the ability to interact with successive inspection and test activities to the extent defined by a respective hold point condition.

2. The computing system of claim 1, wherein the program instructions stored on the non-transitory computer-readable medium are further executable by the at least one processor such that the computing system is further configured to:
present a first interface through which the computing system receives the definitions of the plurality of inspection and test activities that are to be included in an ITP for the construction project.

3. The computing system of claim 1, wherein the record evidences completion of the given inspection and test activity.

4. The computing system of claim 1, wherein the definitions of a plurality of inspection and test activities that are to be included in an ITP include, for a second inspection and test activity of the plurality, a corresponding hold point condition.

5. The computing device of claim 4, wherein the program instructions stored on the non-transitory computer-readable medium are further executable by the at least one processor such that the computing system is further configured to:
based on the hold point condition, present the definitions of the plurality of inspection and test activities to the at least one assignee with at least one conditional restriction a user's ability to interact with the second inspection and test activity.

6. The computing device of claim 5, wherein releasing a restriction on the ability to interact with successive inspection and test activities to the extent defined by a respective hold point condition comprises:
releasing the conditional restriction on a user's ability to interact with the second inspection and test activity.

7. The computing system of claim 6, wherein the record evidences completion of the given inspection and test activity.

8. A method comprising:
receiving definitions of a plurality of inspection and test activities that are to be included in an inspection and test plan (ITP) for a construction project;
publishing the ITP by making the ITP available to at least one assignee;
presenting the definitions of the plurality of inspection and test activities to the at least one assignee;
receiving an indication of a record to link to a first inspection and test activity of the plurality;
receiving an indication that at least one assignee has signed-off on the first inspection and test activity; and
in response to receiving the indication that at least one assignee has signed-off on the first inspection and test activity, releasing a restriction on the ability to interact with successive inspection and test activities to the extent defined by a respective hold point condition.

9. The method of claim 8, further comprising:
presenting a first interface through which the computing system receives the definitions of the plurality of inspection and test activities that are to be included in an ITP for the construction project.

10. The method of claim 8, wherein the record evidences completion of the given inspection and test activity.

11. The method of claim 8, wherein the definitions of a plurality of inspection and test activities that are to be included in an ITP include, for a second inspection and test activity of the plurality, a corresponding hold point condition.

12. The method of claim 11, further comprising:
based on the hold point condition, present the definitions of the plurality of inspection and test activities to the at least one assignee with at least one conditional restriction a user's ability to interact with the second inspection and test activity.

13. The method of claim 12, further comprising:
releasing the conditional restriction on a user's ability to interact with the second inspection and test activity.

14. The method of claim 13, wherein the record evidences completion of the given inspection and test activity.

15. A non-transitory computer-readable storage medium having program instructions stored thereon that are executable to cause a computing system to:
receive definitions of a plurality of inspection and test activities that are to be included in an inspection and test plan (ITP) for a construction project;
publish the ITP by making the ITP available to at least one assignee;
present the definitions of the plurality of inspection and test activities to the at least one assignee;
receive an indication of a record to link to a first inspection and test activity of the plurality;
receive an indication that at least one assignee has signed-off on the first inspection and test activity; and
in response to receiving the indication that at least one assignee has signed-off on the first inspection and test activity, release a restriction on the ability to interact with successive inspection and test activities to the extent defined by a respective hold point condition.

16. The non-transitory computer-readable storage medium of claim 15, wherein the program instructions are further executable to:
present a first interface through which the computing system receives the definitions of the plurality of inspection and test activities that are to be included in an ITP for the construction project.

17. The computing system of claim 15, wherein the record evidences completion of the given inspection and test activity.

18. The non-transitory computer-readable storage medium of claim 15, wherein the definitions of a plurality of inspection and test activities that are to be included in an ITP include, for a second inspection and test activity of the plurality, a corresponding hold point condition.

19. The non-transitory computer-readable storage medium of claim 15, wherein the program instructions are further executable to:
based on the hold point condition, present the definitions of the plurality of inspection and test activities to the at least one assignee with at least one conditional restriction a user's ability to interact with the second inspection and test activity.

20. The non-transitory computer-readable storage medium of claim 19, wherein releasing a restriction on the ability to interact with successive inspection and test activities to the extent defined by a respective hold point condition comprises:
releasing the conditional restriction on a user's ability to interact with the second inspection and test activity.
